(19) United States
(12) Patent Application Publication
(10) Pub. No.: US 2018/0318977 A1
(43) Pub. Date: Nov. 8, 2018

(54) ADAPTIVE COOLING CONTROL SYSTEM AND METHOD FOR AXIAL SYSTEM OF MACHINING CENTER

(71) Applicant: YEONG CHIN MACHINERY INDUSTRIES CO., LTD., Taichung City (TW)

(72) Inventors: Min-Sin Liou, Taichung City (TW); Yi-Liu Pan, Taichung City (TW); Yu-Te Shen, Taichung City (TW); Hao-Wei Huang, Taichung City (TW)

(21) Appl. No.: 15/586,293

(22) Filed: May 4, 2017

(51) Int. Cl. B23Q 11/14; B23Q 17/00; G05B 19/4065

(52) U.S. Cl. CPC B23Q 11/141; G05B 2219/35181; G05B 19/4065; B23Q 17/007

(57) ABSTRACT

An adaptive cooling control method used in an adaptive cooling control system includes a controller installed in a machining center, a temperature sensor installed in a main shaft unit of the machining center, a temperature acquisition device and a main shaft cooling system. A built-in macro program unit of the controller determines whether the temperature of the main shaft falls within a predefined temperature rise range, and if so, the current cooling control parameters are maintained. If the temperature of the main shaft exceeds the predefined temperature rise range, appropriate cooling control parameters are calculated and provided to the dmain shaft cooling system for an adaptive control.

### BACKGROUND OF THE INVENTION

### (a) Field of the Invention

The present invention relates to an adaptive cooling control system and method for axial system of machining center, which acquires the speed and temperature signals of the main shaft of the machining center, calculates the optimal cooling control parameters according to the speed and temperature signal acquired, and feeds the optimal cooling control parameters to the cooling control system to automatically achieve optimal cooling control, maintaining the machining precision of the machining center.

### (b) Description of the Prior Art:

In recent years, the development of the machining center industry has been moving toward the field of high speed and high precision. However, a high speed machining center will generate a large amount of heat during its operation, affecting the machining center precision. When the main shaft of a high speed machining center rotates at a high speed, heat is continuously generated and accumulated in the machining center, thereby affecting the machining precision of the main shaft. In a long machining operation under the impact of environmental temperature, the machining precision problem will be exacerbated. Facing this problem, some machining center manufacturers implement one of the conventional measures of (1) heat source isolation technique and (2) heat source removal technique.

This heat source isolation technique is to use component parts made of materials with low conductivity or thermal expansion coefficient, or to isolate heat energy from the main shaft or to cool down the temperature of the main shaft. However, this heat source isolation technique requires high cost and high technical threshold, and is difficult to protect the main shaft against thermal deformation.

The heat source removal technique is to install a cooling system for circulation of a coolant through a cooling loop in the main shaft unit of the machining center to carry heat away from the main shaft. However, this heat source removal technique is to achieve cooling control according to predetermined cooling parameters. This technique can carry heat away from the main shaft, however, it does not consider the relation between the amount of heat in the main shaft and the amount of coolant to be supplied by the cooling control system, thus resulting in main shaft temperature instability and main shaft expanding and contracting problems.

Further, a new coolant flow rate control technique is known. This new coolant flow rate control technique is to regulate the flow rate of the supplied coolant according to the speed of the main shaft of the main shaft unit of the machining center. However, this new coolant flow rate control technique achieves flow rate adjustment by means of pressure change. It cannot take into account the heat exchange rate, pressure range and maximum flow rate that the original cooling pipe design can withstand. Thus, this new coolant flow rate control technique is less effective in thermal deformation improvement, and can lead to cooling pipeline damage and noise problems.

Due to the aforesaid problems, the cooling system cannot stably and accurately achieve the cooling performance, resulting in rough workpiece surface. Improvement on conventional cooling control techniques is needed.

### SUMMARY OF THE INVENTION

The present invention has been accomplished under the circumstances in view. It is one object of the present invention to provide an adaptive cooling control method used in an adaptive cooling control system comprising a controller installed in a machining center, a temperature sensor installed in a main shaft unit of the machining center, a temperature acquisition device and a main shaft cooling system. In the implementation of the adaptive cooling control method, a built-in macro program unit of the controller can determine whether the temperature of the main shaft falls within a predefined temperature rise range. If so, the current cooling control parameters are maintained. If the temperature of the main shaft exceeds the predefined temperature rise range, appropriate cooling control parameters are calculated and provided to the dmain shaft cooling system for an adaptive control.

The adaptive cooling control system and method for main shaft unit of machining center is to perform an adaptive cooling control action according to signal analysis and optimization control theory so as to achieve the effect in adaptive cooling control. This method alleviates the problem of expanding and contracting of the main shaft in the conventional cooling control technology that does not consider the relation between the heat energy that is generated due to speed change of the machining center main shaft unit in the operation and the amount of coolant provided by the cooling system.

Other advantages and features of the present invention will be fully understood by reference to the following specification in junction with the accompanying drawings, in which like reference signs denote like components of structure.

### BRIEF DESCRIPTION OF THE DRAWINGS

FIG. 1 is a block diagram of an adaptive cooling control system in accordance with the present invention.

FIG. 2 is a system operational block diagram of the adaptive cooling control system in accordance with the present invention.

FIG. 3 is a flow chart of an adaptive cooling control method in accordance with the present invention.

### DETAILED DESCRIPTION OF THE PREFERRED EMBODIMENTS

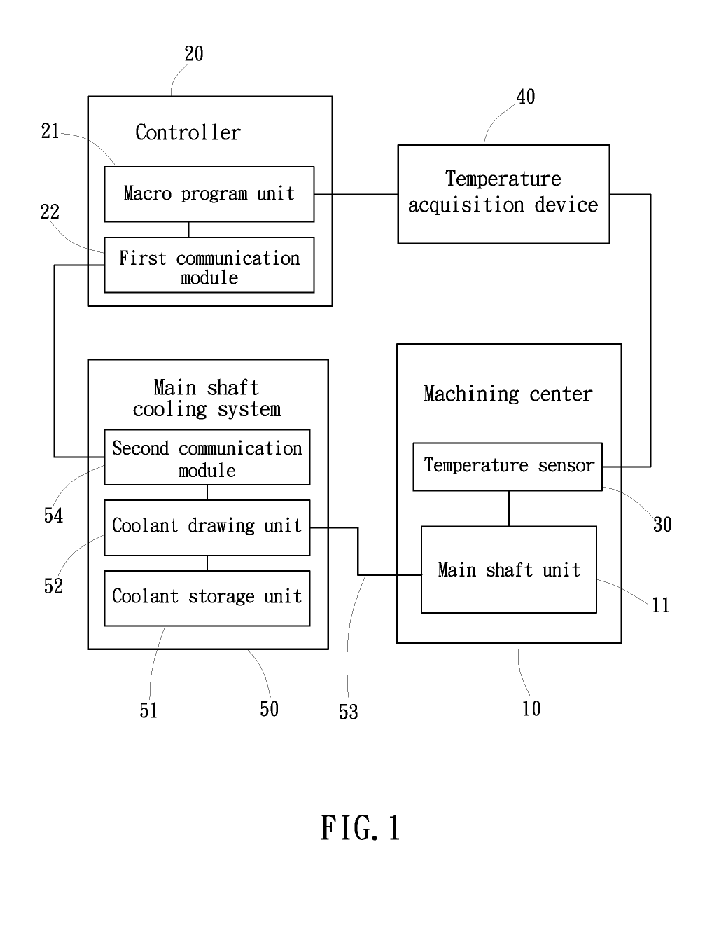

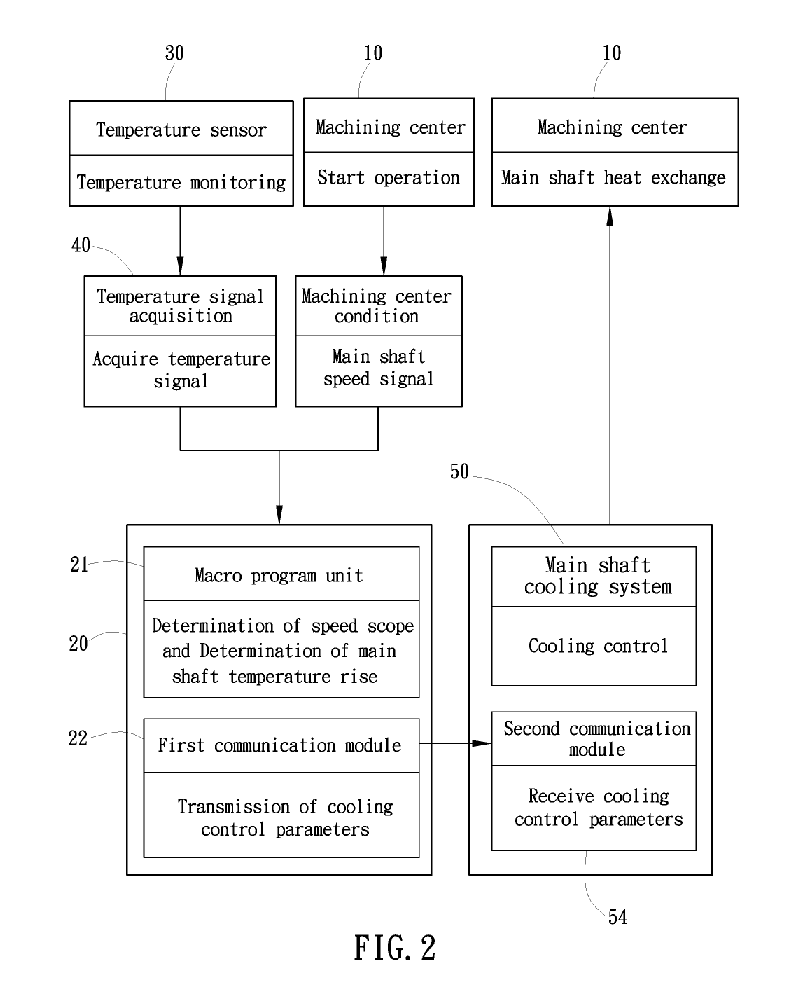

The invention provides an adaptive cooling control system and method for main shaft unit of machining center that is adapted to acquire the speed and temperature signal data of the main shaft unit of a machining center for computation to obtain an adaptive main shaft cooling parameter for further cooling control adjustment, and thus, the cooling system can automatically control the cooling operation according to the temperature and speed of the main shaft unit, enabling the machining center to achieve high precision machining. As illustrated in FIGS. 1 and 2, the adaptive cooling control system generally comprises a controller 20 installed in a machining center 10, at least one temperature sensor 30 installed in a main shaft unit 11 of the machining center 10, a temperature acquisition device 40 and a main shaft cooling system 50.

The machining center 10 can be a vertical machining center, horizontal machining center, gantry type machining center or 5-axis machining center, comprising a main shaft unit 11 adapted for driving a cutting tool (not shown).

The controller 20 is a programmable logic controller (PLC) installed in the machining center 10 for the implementation of system monitoring, data computing and analysis and cooling parameter transfer, having built therein a macro program unit 21 and a first communication module 22. The macro program unit 21 is a pre-written program stored in the controller 20 adapted for monitoring the temperature of the main shaft unit 11 of the machining center 10 through the temperature sensor 30 and the temperature acquisition device 40, and then using the monitored data to determine appropriate cooling control parameters. The first communication module 22 is an I/O module for connection to the main shaft cooling system 50.

The at least one temperature sensor 30 is installed in a heat generating area around the main shaft unit 11 of the machining center 10, and adapted for detecting the temperature of the main shaft unit 11 of the machining center 10 and providing the detected temperature data to the temperature acquisition device 40.

The temperature acquisition device 40 is electrically coupled with the temperature sensor 30 and the controller 20, and adapted for acquiring the temperature signal detected by the temperature sensor 30, filtering the acquired temperature signal to remove noises and converting the filtered temperature signal into a digital data signal.

The main shaft cooling system 50 is a peripheral apparatus mounted in the machining center 10, comprising a coolant storage unit 51 for storing a coolant, a coolant drawing unit 52 (pump) connected to the coolant storage unit 51 for drawing the stored coolant out of the coolant storage unit 51, a pipeline 53 connected to the coolant drawing unit 52 and the main shaft unit 11, and a second communication module 54 mounted in the coolant drawing unit 52. The second communication module 54 is an I/O module connected to the first communication module 22 of the controller 20, and controllable by the controller 20 to deliver the coolant to the main shaft unit 11 and to carry away the heat energy generated by the main shaft unit 11 during operation, enabling the temperature of the main shaft unit 11 to be controlled within a predetermined temperature range and preventing transfer of heat to the head casting member to affect machining precision.

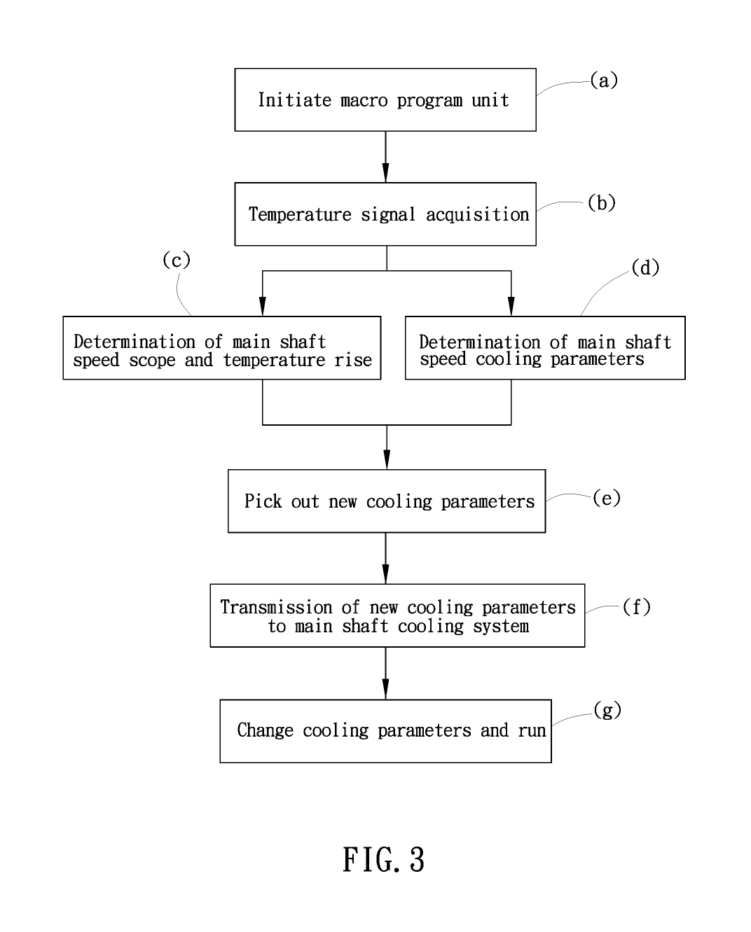

Referring to FIG.2 and FIG.3, according to the arrangement of the controller 20, the temperature sensor 30, the temperature acquisition device 40 and the main shaft cooling system 50 relative to the main shaft unit 11 of the machining center 10, the implementation of the adaptive cooling control method in the adaptive cooling control system and method comprises the steps of:

(a) Initiate the macro program unit 21.

(b) Temperature signal acquisition: Enable the temperature sensor 30 to detect the temperature signal of the main shaft unit 11 of the machining center 10 during its operation, and then to feed the detected temperature signal to the temperature acquisition device 40, and then enable the temperature acquisition device 40 to filter the temperature signal and to convert the temperature signal into a digital data signal readable by the controller 20 and then to feed the digital data signal to the controller 20.

(c) Determination of main shaft speed scope and temperature rise: Enable the build-in macro program unit 21 of the controller 20 to determine the scope of the speed range and the extent of temperature rise of the main shaft according to the speed (rpm) of the main shaft unit 11 of the machining center 10, wherein the scope of the speed range of the macroprogram unit 21 includes multiple ranges, for example, a first speed range within 5000 rpm-8000 rpm, a second speed range within 8001 rpm-10000 rpm, a third speed range within 10001 rpm-13000 rpm, so on and so forth; the macroprogram unit pre-establish a set of temperature data in advance to determine the degree of temperature rise of the main shaft 11;

(d) Determination of main shaft speed cooling parameters: Enable the macro program unit 21 to determine whether the temperature of the main shaft generated subject to the current speed range falls within a predefined temperature rise range, if so, the current cooling control parameters are maintained;

(e) Pick out new cooling parameters: Enable the macro program unit 21 to automatically calculate new cooling control parameters according to the current main shaft speed and temperature rise.

(f) Transmission of new cooling parameters to the main shaft cooling system: Enable the controller 20 to transmit the new cooling parameters through the first communication module 22 to the second communication module 54 of the main shaft cooling system 50.

(g) Change cooling parameters and run: Enable the main shaft cooling system 50 to change the cooling parameters immediately after the second communication module 54 receives the new cooling parameters, driving the coolant drawing unit 52 to deliver an appropriate amount of coolant to the main shaft unit 11 for cooling (by heat exchange), thereby maintaining high machining precision of the main shaft unit 11 of the machining center 10.

The adaptive cooling control system and method for main shaft unit of machining center is to acquire the main shaft temperature and speed signals during the operation of the machining center 10 so that the built-in macro program unit 21 of the controller 20 can determine whether the temperature of the main shaft falls within a predefined temperature rise range.

If so, the current cooling control parameters are maintained. If the temperature of the main shaft exceeds the defined temperature rise range, appropriate cooling control parameters are calculated and provided to the main shaft cooling system for an adaptive control.

What is claimed is:

1. An adaptive cooling control system, comprising a controller installed in a machining center, at least one temperature sensor installed in a main shaft unit of said machining center, a temperature acquisition device and a main shaft cooling system, said controller having built therein a macro program unit, said macro program unit being adapted for monitoring the temperature of said main shaft unit of said machining center through said at least one temperature sensor and said temperature acquisition device and then using the monitored temperature data to determine appropriate cooling control parameters, said at least one temperature sensor being installed in a heat generating area around said main shaft unit of said machining center and adapted for detecting the temperature of said main shaft unit of said machining center and providing the detected temperature data to said temperature acquisition device, said temperature acquisition device being electrically coupled with said temperature sensor and said controller and adapted for acquiring the temperature signal detected by said at least one temperature sensor, filtering the acquired temperature signal to remove noises, converting the filtered temperature signal into a digital data signal and providing said digital data signal to said macro program unit, said main shaft cooling system being mounted in the machining center and adapted for receiving cooling control parameters from said macro program unit and delivering a coolant to said main shaft unit to cool down said main shaft unit.

2. The adaptive cooling control system as claimed in claim 1, wherein said controller comprises a first communication module connected to said main shaft cooling system.

3. The adaptive cooling control system as claimed in claim 2, wherein said main shaft cooling system comprises a coolant storage unit for storing a coolant, a coolant drawing unit connected to said coolant storage unit for drawing the stored said coolant out of said coolant storage unit, a pipeline connected to said coolant drawing unit and said main shaft unit, and a second communication module connected to said first communication module of said controller for receiving said cooling control parameters.

4. The adaptive cooling control system as claimed in claim 1, wherein said machining center is selected from the group consisting of vertical machining center, horizontal machining center, gantry type machining center and 5-axis machining center.

5. An adaptive cooling control method used in the adaptive cooling control system as claimed in claim 1, comprising the steps of:
(a) initiating said macro program unit;
(b) using said temperature sensor to detect the temperature signal of said main shaft unit of said machining center during operation, and then to feed the detected temperature signal to said temperature acquisition device, and then using said temperature acquisition device to filter said detected temperature signal and to convert said detected temperature signal into a digital data signal readable by said controller and then to feed said digital data signal to said controller;
(c) causing said macro program unit of said controller to determine the scope of the speed range and the extent of temperature rise of said main shaft according to the speed (rpm) of said main shaft unit of said machining center;
(d) causing said macro program unit to determine whether the temperature of the main shaft generated subject to the current speed range falls within a defined temperature rise range;
(e) enabling causing said macro program unit to automatically calculate new cooling control parameters according to the current main shaft speed and temperature rise when the temperature of said main shaft surpasses a predetermined temperature range;
(f) causing said controller to transmit said new cooling parameters through said first communication module to said second communication module of said main shaft cooling system; and
(g) enabling causing said main shaft cooling system to change the cooling parameters and then to drive said coolant drawing unit to deliver an appropriate amount of coolant to said main shaft unit for cooling.

6. The adaptive cooling control method as claimed in claim 5, further comprising a sub step of enabling said main shaft cooling system to maintain the current cooling control parameters after step (d) if the temperature of the main shaft generated subject to the current speed range falls within said defined temperature rise range.
